(19) United States
(12) Patent Application Publication
(10) Pub. No.: US 2013/0162511 A1
(43) Pub. Date: Jun. 27, 2013

(54) ELECTRONIC PAPER DISPLAY DEVICE

(71) Applicants: WEI-GUO XIAO, Shenzhen (CN); YI-YING CHEN, New Taipei (TW); CHIU-HSIUNG LIN, New Taipei (TW)

(72) Inventors: WEI-GUO XIAO, Shenzhen (CN); YI-YING CHEN, New Taipei (TW); CHIU-HSIUNG LIN, New Taipei (TW)

(21) Appl. No.: 13/689,768

(22) Filed: Nov. 30, 2012

(30) Foreign Application Priority Data
Dec. 23, 2011 (CN) 201110437289.X

(51) Int. Cl. G06F 1/16

(52) U.S. Cl. CPC G06F 1/1637
USPC 345/107

(57) ABSTRACT

An E-paper display device an transparent upper substrate and a plurality of transparent and paralleled column electrodes attached on the upper substrate; a lower substrate and a plurality of parallel row electrodes attached on the lower substrate; and an electrophoretic medium arranged between the column electrodes and the row electrodes. The electrophoretic medium is brought to different optical states via controlling electric voltages between the column electrodes and the row electrodes. The E-paper display device is thinner, cheaper, and lighter than a E-paper display device employing a TFT pixel electrode.

### BACKGROUND

1. Technical Field

The present disclosure relates to display devices and, more particularly, to an electrophoretic display device.

2. Description of Related Art

Electrophoretic effects are well known among scientists and engineers, wherein electrophoretic particles dispersed in a fluid or liquid medium move under the influence of an electric field. For use as an electronic paper (E-paper) display device, an electrophoretic display is preferred over a liquid crystal display (LCD) because of a better reflectivity and contrast ratio. A typical E-paper display device includes a common electrode, a Thin Film Transistor (TFT) pixel electrode and an electrophoretic medium arranged between the common electrode and the pixel electrode.

The TFT pixel electrode is a special kind of field-effect transistor made by depositing thin films of a semiconductor active layer as well as the dielectric layer and metallic contacts over a supporting substrate. The TFT pixel electrode is too thick to meet the demands of thinner, lighter of the electronic paper display device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, cross-sectional view showing an electronic paper (E-paper) display device in accordance with an exemplary embodiment.

FIG. 2 is a schematic, cross-sectional view showing an electrophoretic medium of the E-paper display device of FIG. 1.

FIG. 3 is a schematic, planar view of row electrodes and column electrodes of the E-paper display device of FIG. 1.

FIG. 4 is a schematic view of a driving signal applied on the row electrodes and the column electrodes of the E-paper display device of FIG. 1 in accordance with an exemplary embodiment.

FIG. 5 is a schematic view of a driving wave form of a pixel of the electrophoretic display device of FIG. 1.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

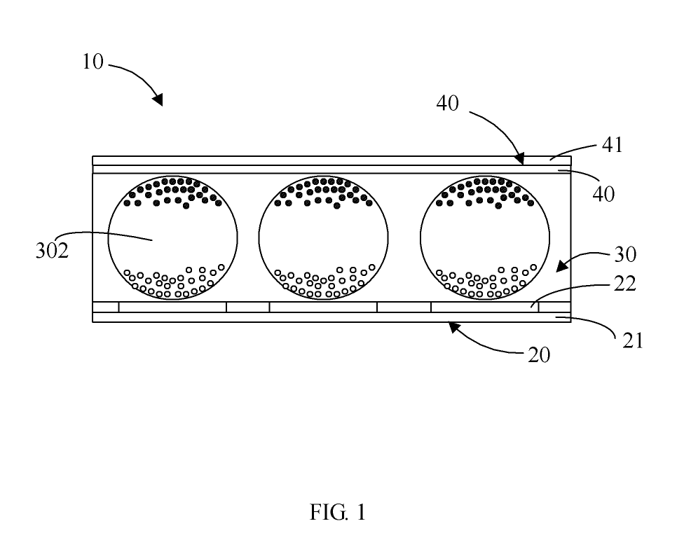

FIG. 1 shows an E-paper display device 10 according to an exemplary embodiment. The E-paper display device 10 includes a lower substrate 20, an electrophoretic medium 30, an upper substrate 40, a power unit (not shown), and a driving circuit (not shown). The electrophoretic medium 30 is arranged between the lower substrate 20 and the upper substrate 40.

The lower substrate 20 can be made of plastic, or glass, for example. The lower substrate 20 includes a base 21 and a plurality of paralleled row electrodes 22 arranged between the base 21 and the electrophoretic medium 30. A chemistry etching, film printing processing or projection photolithography can be employed to form the plurality of paralleled row electrodes 22 on the surface of the base 21.

The upper substrate 40 can be made of glass, or other transparent materials of high light propagation efficiency, such as polyimide (PI), polycarbonate (PC), or polyethylene terephthalate (PET) or polymethylmethacrylate (PMMA). The upper substrate 40 includes a base 41 and a plurality of paralleled column electrodes 42. The plurality of paralleled column electrodes 42 is transparent and arranged between the base 41 and the electrophoretic medium 30. A chemistry etching, film printing processing or projection photolithography can be employed to form the plurality of paralleled column electrodes 42 on a surface of the base 41, which corresponds to a display surface of the upper substrate 40 to be viewed by a person such as an operator. The paralleled column electrodes 42 can be made of indium tin oxide (ITO).

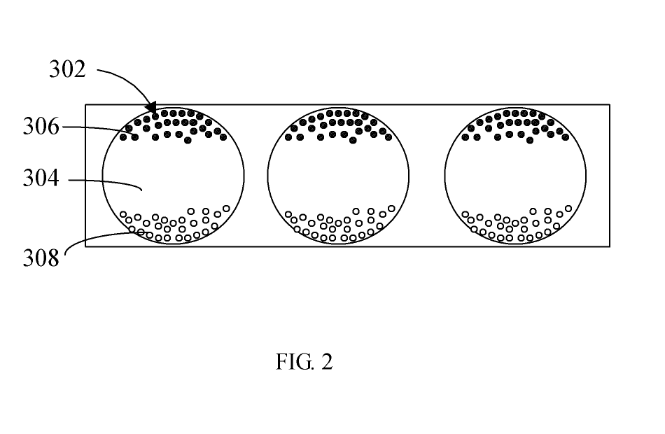

FIG. 2 shows that in this embodiment, the electrophoretic medium 30 described here is microcapsule electrophoretic medium with bistable characteristic. The electrophoretic medium 30 includes a plurality of microcapsules 302, each of which includes a capsule wall (not labeled) containing dielectric solution 304 in which a plurality of first electrophoretic particles 306 and a plurality of second electrophoretic particles 308 are suspended. The first electrophoretic particles 306 and the second electrophoretic particles 308 are provided with different optical and electrical properties. For example, in this embodiment, the first electrophoretic particles 306 is the positive electrophoretic particles with white pigment and the second electrophoretic particles 303 is the negatively electrophoretic particles with black pigment.

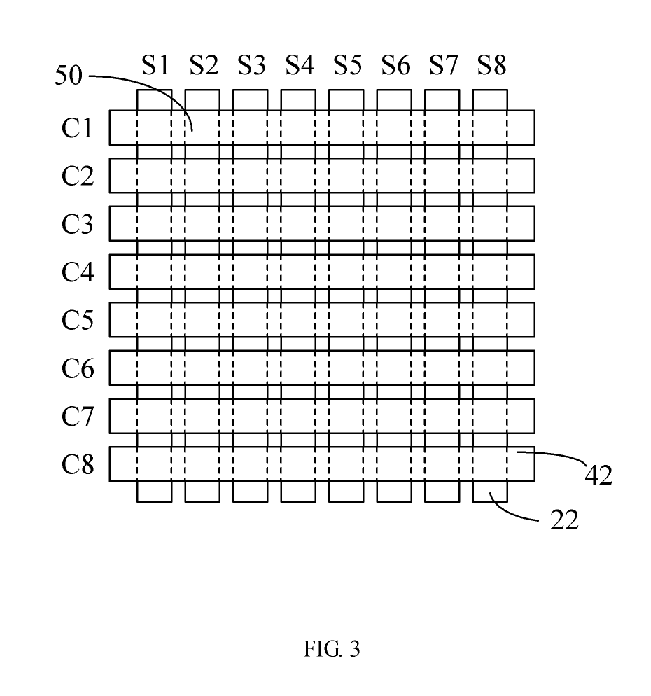

FIG. 3 shows that the row electrodes 22 and the column electrodes 42 are rectangular stripe shaped, and the plurality of paralleled row electrodes 22 are perpendicular to the plurality of paralleled column electrodes 42. The intersection regions of the row electrodes 22 and the column electrodes 42 form a matrix of pixels 50 of the E-paper display device 10. Each of the pixels is formed by the intersection of a row electrode 22 and a column electrode 42. Applying a voltage to the row electrodes 22 and the column electrodes 42, an electrical field is formed between the intersection regions of the row electrodes 22 and the column electrodes 42, the electrophoretic medium 30 is switchable between different optical states in response to electrical voltages created between the column electrodes 42 and the row electrodes 41. In each pixel 50, the first electrophoretic particles 306 or the second electrophoretic particles 308 move to the column electrodes 42 to form images on the E-paper display device 10.

In this embodiment, the row electrodes 22 are scanning electrodes, a scanning signal is applied on the row electrodes 22, and the column electrodes 42 are signal electrodes, a dynamic driving signal is applied on the column electrodes 42. The electrophoretic medium 30 is refreshed by the electrical field formed between the row electrodes 22 and the column electrodes 42 according to the dynamic driving signal. In other embodiments, the row electrodes 22 are signal electrodes and the column electrodes 42 are scanning electrodes.

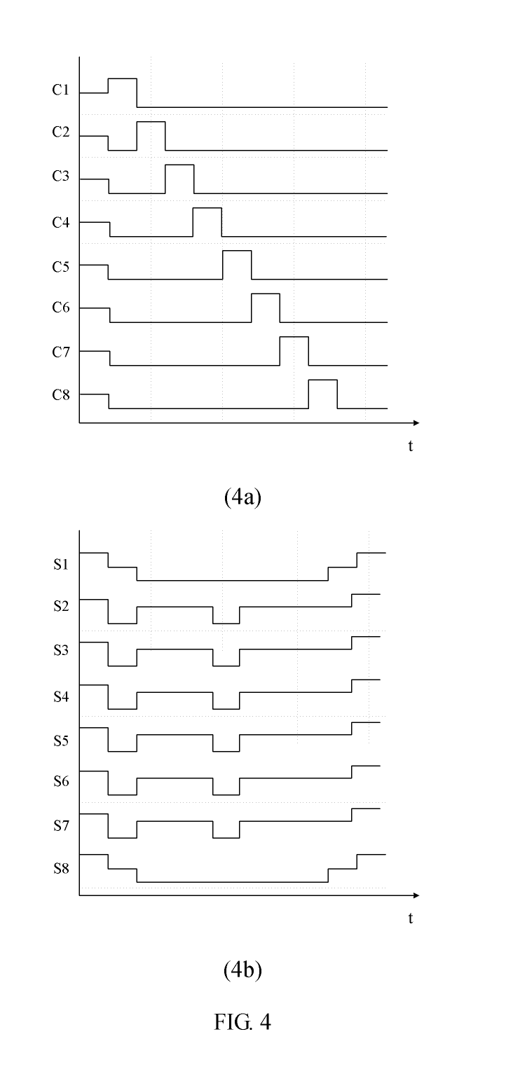

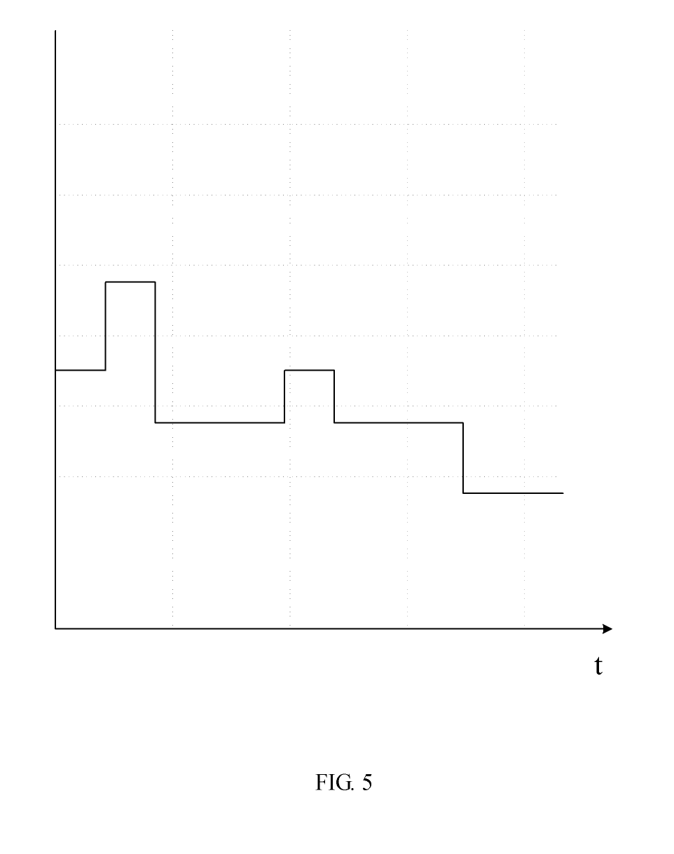

FIG. 4 shows a scanning signal applied on the row electrodes 22 in FIG. 4a, and a dynamic driving signal applied on the column electrodes 42 in FIG. 4b according to an exemplary embodiment. An electric voltage diagram of the pixel 50 in the intersection region of the row electrode C1 and the column electrode S2 is shown in FIG. 5 according to the scanning signal and the dynamic driving signal given in FIG. 4.

The electrical field intensity of the pixel 50 is V, the refreshing time is T.

The formula of a moving distance L1 of the first electrophoretic particles 306 is L₁=k₁ ∫₀^{T} ∫_{31 V}^{V} f(v,t)dvdt; and the formula of a moving distance L2 of the second electrophoretic particles 308 is L₂=ₖ₂ ∫₀^{T} ∫_{-V}^{V} f(v,t)dvdt.

The optical states of the pixel 50 depends on the location of the first electrophoretic particles 306 and the second electrophoretic particles 308 in the microcapsules 302. The location of the first electrophoretic particles 306 and the second electrophoretic particles 308 further depends on their movement distance during refreshing time. The optical states of the pixel 50 can be controlled via controlling the scanning signal applied on the corresponding row electrode 22 and the dynamic driving signal applied on the corresponding column electrode 42.

The electrophoretic medium 30 is driven by the rectangular stripe electrodes arranged on the opposite surfaces of the upper substrate 40 and the lower substrate 20, the E-paper display device 10 is thinner, cheaper and lighter than a E-paper display device employing a TFT pixel electrode.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An E-paper display device, comprising:
a transparent upper substrate;
a plurality of transparent and paralleled column electrodes formed on the upper substrate;
a lower substrate;
a plurality of formed row electrodes attached on the lower substrate; and
an electrophoretic medium arranged between the column electrodes and the row electrodes;
wherein the plurality of paralleled row electrodes are perpendicular to the plurality of paralleled column electrodes, the electrophoretic medium is switchable between different optical states in response to electrical voltages created between the column electrodes and the row electrodes.

2. The E-paper display device of claim 1, wherein intersection regions of the row electrodes and the column electrodes form a matrix of pixels.

3. The E-paper display device of claim 1, wherein the column electrodes are made of indium tin oxide.

4. The E-paper display device of claim 1, wherein the upper substrate is made of transparent materials.

5. The E-paper display device of claim 1, wherein the lower substrate is made of plastic or glass.

6. The E-paper display device of claim 1, wherein the electrophoretic medium is an electrophoretic ink with bistable characteristics.

7. The E-paper display device of claim 6, wherein the electrophoretic medium is a microcapsule electrophoretic medium.

8. An E-paper display device, comprising:
an upper electrode layer comprising a plurality of transparent and paralleled column electrodes;
a lower electrode layer comprising a plurality of paralleled row electrodes; and
an electrophoretic medium arranged between the column electrodes and the row electrodes;
wherein the plurality of paralleled row electrodes are perpendicular to the plurality of paralleled column electrodes, the electrophoretic medium is swichable between different optical states in response to electrical voltages created between the column electrodes and the row electrodes.

9. The E-paper display device of claim 8, wherein intersection regions of the row electrodes and the column electrodes form a matrix of pixels.

10. The E-paper display device of claim 8, wherein the column electrodes are made of indium tin oxide.

11. The E-paper display device of claim 8, wherein the upper substrate is made of transparent materials.

12. The E-paper display device of claim 8, wherein the lower substrate is made of plastic or glass.

13. The E-paper display device of claim 8, wherein the electrophoretic medium is an electrophoretic ink with bistable characteristics.

14. The E-paper display device of claim 13, wherein the electrophoretic medium is a microcapsule electrophoretic medium.
